(19) United States
(12) Patent Application Publication
(10) Pub. No.: US 2026/0346514 A1
(43) Pub. Date: Nov. 5, 2026

(54) Method for Integrally Molding Multicolor Products Using a Supercritical Thermoplastic Polyurethane Foaming Mold

(71) Applicant: AncesPro Industrial Co., Ltd., Taichung City (TW)

(72) Inventor: Shao-Wei Hsu, Taichung City (TW)

(21) Appl. No.: 19/194,229

(22) Filed: Apr. 30, 2025

(51) Int. Cl. B29C 44/34; B29C 44/12; B29K 75/00; B29K 105/04; B29L 31/50

(52) U.S. Cl. CPC B29C 44/3415; B29C 44/1271; B29K 2075/00; B29K 2105/04; B29K 2995/0021; B29L 2031/504

(57) ABSTRACT

A method for integrally molding multicolor products using a supercritical thermoplastic polyurethane foaming mold, through the implementation of the sequential surface member manufacturing step, a placing and heating step, a material injection step, a foaming and fusion step, and a cooling and curing step, etc., a product with multiple colors can be obtained in a single foaming and molding process. There is no need to carry out surface modification or secondary processing after foaming and molding to achieve the matching of multiple colors, such as dyeing, coating, or laminating other materials. Therefore, the present invention effectively improves production efficiency, saves costs, and achieves the sustainable development goal of resource recycling and reuse.

### BACKGROUND

### Field of the Invention

The present invention relates to a method for integrally molding products, and more particularly to a method for integrally molding multicolor products using a supercritical thermoplastic polyurethane (TPU) foaming mold.

### Description of Related Art

The supercritical TPU (thermoplastic polyurethane) foaming mold is an advanced technology specifically used for manufacturing lightweight and highly elastic products. This technology mainly utilizes supercritical fluids (such as carbon dioxide or nitrogen) as blowing agents. Under high pressure, the supercritical fluids are dissolved in the TPU material. Subsequently, the pressure is released inside the mold, causing fine and uniform bubble structures to form within the material, achieving the purposes of reducing weight, enhancing the cushioning effect, and minimizing the environmental impact.

The plastic products integrally formed by the supercritical TPU foaming mold can be the mid-soles of sports shoes and casual shoes, sports equipment such as cushion pads, protective gear, and yoga mats, medical and assistive devices such as orthopedic insoles and prosthetic liners, and automotive or bicycle components such as seat cushions and seals.

However, although the supercritical TPU foaming technology has many advantages, it can only form monochromatic items. This is mainly because supercritical fluids need to be dissolved inside the TPU under high pressure. If particles or pigments of multiple colors are added, it may lead to uneven distribution, affecting the foaming effect and the consistency of the final product. In addition, under supercritical conditions, the solubility and diffusion characteristics of pigments are different from those in traditional melt blending. If an attempt is made to mix multiple colors, due to differences in density or affinity, color stratification or uneven defects may occur after foaming.

Therefore, if the plastic products integrally formed by the supercritical TPU foaming mold are to have multiple colors, only subsequent processing can be carried out, thus highlighting the defects of being labor-intensive and time-consuming. For example, when it is desired to create patterns of different colors on the peripheral wall surface of the shoe mid-sole, the injection-molded shoe mid-sole needs to be transported elsewhere for dyeing, coating, or the adhesion operation of colored patches, resulting in an increase in production costs. In addition, the colored patches and the shoe mid-sole are made of different materials, resulting in different use formulas or additives for the two plastic materials. This makes the quality of the mixed plastics after recycling unstable and affects the application value of recycled plastics. Although the goal of carbon neutrality can be achieved, the sustainable development goal of resource recycling and reuse cannot be achieved.

### SUMMARY

The objective of the present invention is to provide a method for integrally molding multicolor products using a supercritical TPU foaming mold, which can solve one of the above problems.

To achieve the above-mentioned objective, a method for integrally molding multicolor products using a supercritical thermoplastic polyurethane foaming mold, sequentially comprises: a surface member manufacturing step, the surface member including a color-differentiated layer and a fusion interface layer, the color-differentiated layer including an inner surface and a first color, the fusion interface layer being disposed on the inner surface, and a melting point of the fusion interface layer being lower than that of the color-differentiated layer; a placing and heating step including placing the surface member in the supercritical TPU foaming mold, heating the supercritical TPU foaming mold with a heating temperature below a melting point of the color-differentiated layer, and causing the fusion interface layer to be in a molten state; a material injection step including injecting a fluid-state main body member into the supercritical TPU foaming mold, the fluid-state main body member having a melting point close to that of the fusion interface layer and a second color different from the first color; a foaming and fusion step including performing a supercritical foaming process on the fluid-state main body member, causing the fluid-state main body member to foam, fuse and bond integrally with the fusion interface layer of the surface member; and a cooling and curing step including cooling the foamed main body member, forming a solid main body member integrated with the surface member.

The effects of the present invention are as follows: Through the implementation of the sequential surface member manufacturing step, a placing and heating step, a material injection step, a foaming and fusion step, and a cooling and curing step, etc., a product with multiple colors can be obtained in a single foaming and molding process. There is no need to carry out surface modification or secondary processing after foaming and molding to achieve the matching of multiple colors, such as dyeing, coating, or laminating other materials. Therefore, the present invention effectively improves production efficiency and saves costs. The product can be a mid-sole of sports shoes and casual shoes, cushion pads of sports equipment, protective gears, bicycle seat cushions, etc.

Preferably, the main body member has a melting point of 180-200 °C, a melting point of the color-differentiated layer is 220-230 °C, while the fusion interface layer has a melting point of 190-200 °C.

Preferably, the main body member is made of polyether TPU, the color-differentiated layer is made of polyester TPU, and the fusion interface layer is made of hot-melt polyurethane adhesive.

Preferably, the supercritical TPU foaming mold includes a lower mold, an upper mold positioned above the lower mold, and a middle mold located between the lower mold and upper mold, the middle mold includes a hollow annular portion, the surface member is disposed in the hollow annular portion, and an outer surface of the color-differentiated layer contacts an annular surface of the hollow annular portion.

### BRIEF DESCRIPTION OF THE DRAWINGS

FIG. 1 is a flowchart of an embodiment of the present invention;

FIG. 2A is a three-dimensional exploded view of an embodiment of the present invention, showing the state of the mold separation;

FIG. 2B is a magnified view of a part of FIG. 2A, showing the state of a part of the surface member;

FIG. 3 is a three-dimensional assembled view of an embodiment of the present invention, showing the state of the setting of the surface member;

FIG. 4 is a combined sectional view of an embodiment of the present invention, showing the sectional state after the mold is closed;

FIG. 5 is a combined sectional view of an embodiment of the present invention, showing the states of injection molding, foaming and curing;

FIG. 6 is a three-dimensional assembled view of an embodiment of the present invention, showing the state of opening the mold to take out the product;

FIG. 7A is a three-dimensional view of an embodiment of the present invention, showing the state of an integrally formed multicolor product;

FIG. 7B is a sectional view of an embodiment of the present invention, showing the sectional state of the multicolor product; and

FIG. 7C is a magnified view of a part of FIG. 7B.

### DETAILED DESCRIPTION

Before the present invention is described in detail, it should be noted that in the following description, similar components are denoted by identical reference numerals.

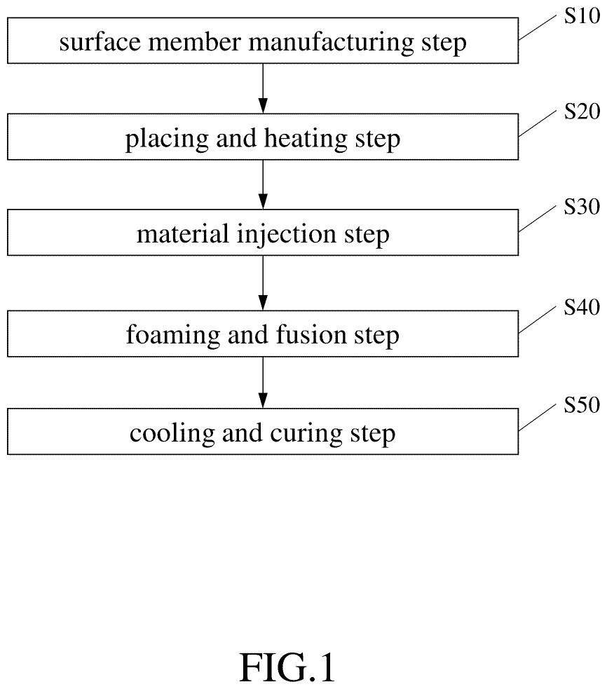

Referring to FIG. 1, a method for integrally molding multicolor products using a supercritical thermoplastic polyurethane (TPU) foaming mold according to an embodiment of the present invention sequentially includes: a surface member manufacturing step S10, a placing and heating step S20, a material injection step S30, a foaming and fusion step S40, and a cooling and curing step S50.

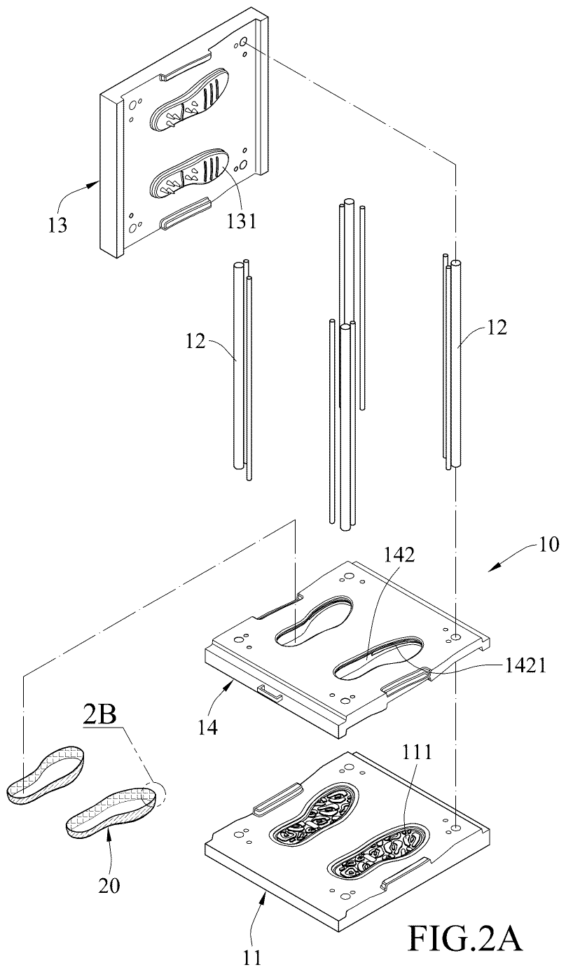

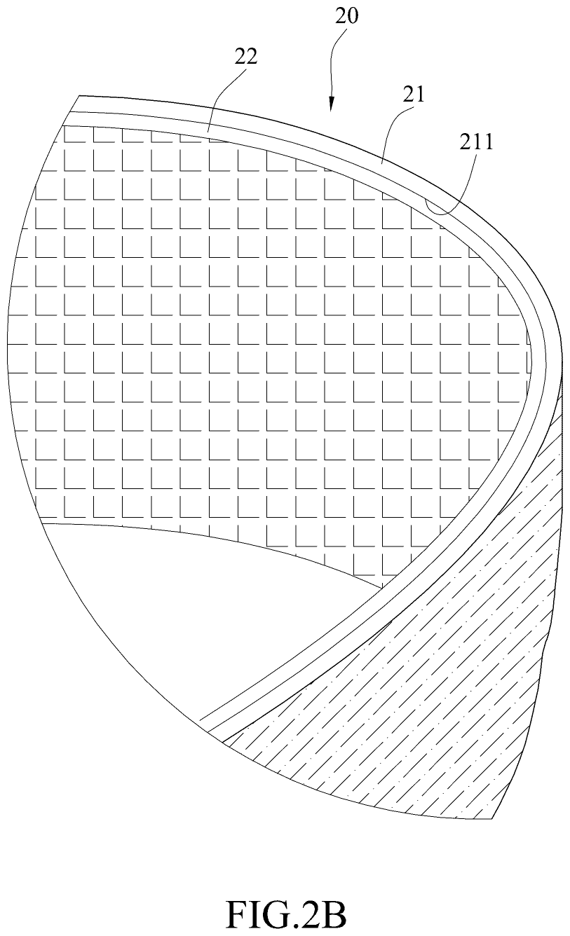

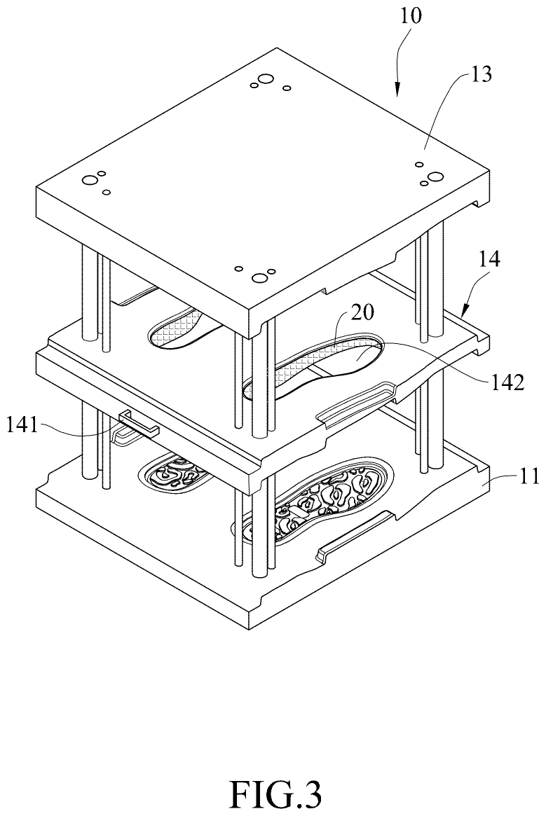

As shown in FIGS. 2A, 3, and 4, the supercritical TPU foaming mold 10 is exemplified as a mold for forming a shoe mid-sole, but is not limited thereto. It may also be a mold for forming cushion pads and protective gear of sports equipment, or bicycle seat cushions. In this embodiment, the supercritical TPU foaming mold 10 includes a lower mold 11, an upper mold 13 positioned above the lower mold 11 and reciprocally movable along guide pillars 12 toward the lower mold 11, and a middle mold 14 located between the lower mold 11 and upper mold 13. The lower mold 11 has a cavity 111 recessed from its top surface. The upper mold 13 has a protrusion 131 extending toward the cavity 111. The middle mold 14 is arranged between the lower mold 11 and the upper mold 13 and can reciprocate along the guide pillars 12. However, it is not limited thereto. The middle mold 14 can also be pivotally arranged on the lower mold 11 at one end, and has a handle portion 141 at the other end, so that the middle mold 14 can complete the mold opening or mold closing with the lower mold 11 in a flipping manner. The middle mold 14 further includes a hollow annular portion 142 corresponding to the cavity 111 and protrusion 131. The inner annular surface of the hollow annular portion 142 is provided with a positioning structure 1421, which may be a concave structure, convex structure, or other structural configurations for bonding with a surface member 20.

As shown in FIGS. 2A and 2B, the surface member manufacturing step S10: The surface member 20 is an annular sheet (but not limited thereto; it may also be a geometric or irregularly shaped sheet). The surface member 20 includes a color-differentiated layer 21 and a fusion interface layer 22. The color-differentiated layer 21 has an inner surface 211 and a first color, the color-differentiated layer 21 may be presented as lines, patterns, text, or logos. The fusion interface layer 22 is disposed on the inner surface 211, and the melting point of the fusion interface layer 22 is lower than that of the color-differentiated layer 21. In this embodiment, the melting point of the color-differentiated layer 21 is 220-230 °C, while the fusion interface layer 22 has a melting point of 190-200 °C. The color-differentiated layer 21 is made of polyester TPU, and the fusion interface layer 22 is made of hot-melt polyurethane adhesive, but is not limited thereto, as long as the characteristics of the fusion interface layer 22 can be used as a bonding material for two objects both made of polyester TPU.

As shown in FIGS. 2A to 4, the placing and heating step S20: Placing the surface member 20 in the supercritical TPU foaming mold 10. In this embodiment, the surface member 20 is disposed in the hollow annular portion 142 of the middle mold 14 and positioned at the positioning structure 1421, with the outer surface of the color-differentiated layer 21 contacting the annular surface of the hollow annular portion 142. After positioning of the surface member 20, the lower mold 11, upper mold 13, and middle mold 14 are closed to form a sealed chamber A. The supercritical TPU foaming mold 10 is then heated with a heating temperature below the melting point of the color-differentiated layer 21 but slightly above the melting point of the fusion interface layer 22, ensuring that the structural form of the color-differentiated layer 21 is not affected by the heating temperature, and the fusion interface layer 22 is in a molten state.

As shown in FIGS. 2B, 4, and 5, the material injection step S30: Injecting a fluid-state main body member 30 into the sealed chamber A of the supercritical TPU foaming mold 10. The fluid-state main body member 30 has a melting point close to that of the fusion interface layer 22 and a second color different from the first color. In this embodiment, the main body member 30 has a melting point of 180-200 °C and is made of polyether TPU, but it is not limited thereto. The melting point of the main body member 30 is close to the melting point of the fusion interface layer 22 of the surface member 20, and it can be bonded with the molten fusion interface layer 22.

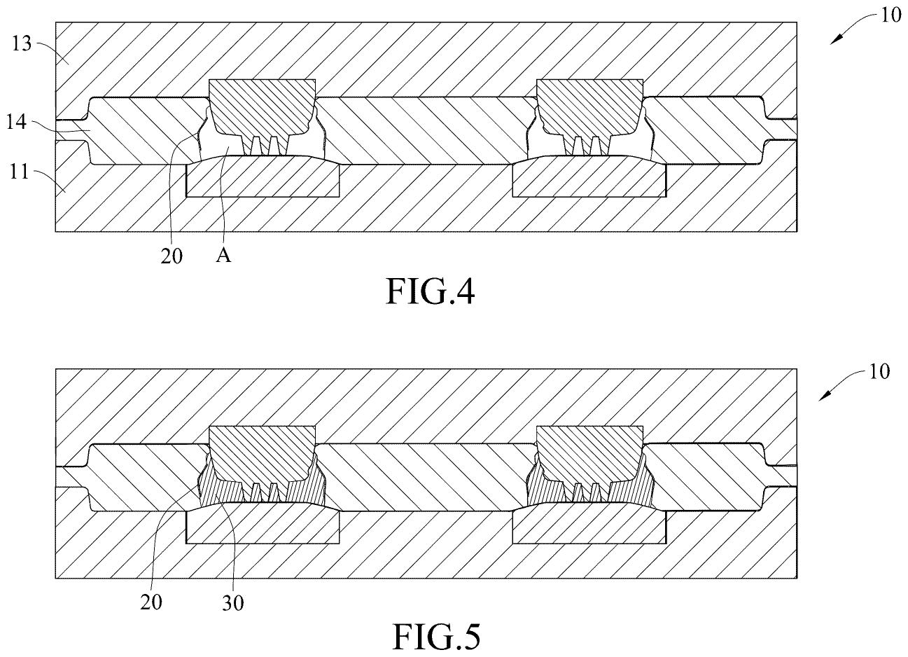

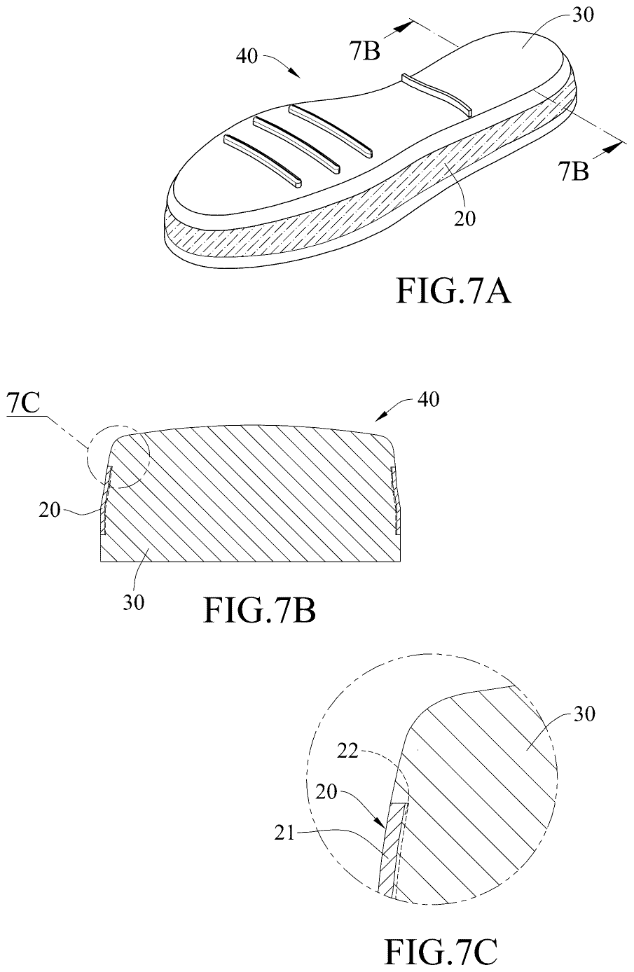

As shown in FIG. 5, the foaming and fusion step S40: Performing a supercritical foaming process on the fluid-state main body member 30, causing the fluid-state main body member 30 to foam, fuse and bond integrally with the fusion interface layer 22 of the surface member 20 (see FIGS. 7B and 7C). Since the method of the supercritical foaming process is the same as the conventional one and is not the focus of the present invention, the methods of the supercritical foaming operation such as introducing supercritical fluid (usually CO₂ or N₂), high temperature and high pressure conditions, and releasing pressure will not be repeated.

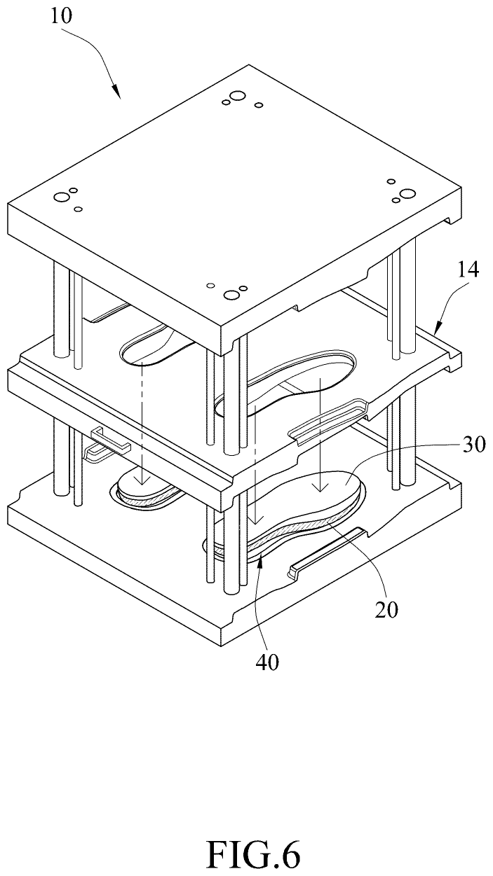

As shown in FIG. 5, the cooling and curing step S50: cooling the foamed main body member 30 to stabilize its cellular structure, forming a solid main body member 30 integrated with the surface member 20. After cooling, the mold 10 is opened, and the product 40 in the form of a shoe mid-sole is removed from the middle mold 14 (FIGS. 6-7C), yielding a multicolor, integrally molded product 40 in the form of a shoe mid-sole.

Accordingly, since the present invention pre-locates the surface member 20 in the positioning structure 1421 of the middle mold 14, and in addition to the design of the color-differentiated layer 21 with a color different from that of the main body member 30, the surface member 20 is further provided with a fusion interface layer 22 that can be fused and bonded with the main body member 30. Therefore, after the material injection step S30, the foaming and fusion step S40, and the cooling and curing step S50, the surface member 20 is not only integrally formed with the main body member 30, but also presents a color different from that of the main body member 30. It can be seen that by the method of the present invention, a product 40 in the form of a shoe mid-sole with multiple colors can be obtained in a single foaming and molding process. There is no need to carry out surface modification or secondary processing after foaming and molding to achieve the matching of multiple colors, such as dyeing, coating, or laminating other materials. Therefore, the present invention effectively improves production efficiency and saves costs. In this embodiment, the product 40 can be a mid-sole of sports shoes and casual shoes, but it is not limited thereto. It can also be a cushion pad of sports equipment, a protective gear, a bicycle seat cushion, etc.

In addition, since the surface member 20 and the main body member 30 used in the present invention are both thermoplastic polyurethane (TPU) materials of the same type, the product 40 can be remelted and reshaped by heating, that is, it can be crushed and remelted to make a new product, reducing resource waste and environmental pollution, so as to achieve the sustainable development goal of resource recycling and reuse.

What is claimed is:

1. A method for integrally molding multicolor products using a supercritical thermoplastic polyurethane foaming mold, sequentially comprising:
a surface member manufacturing step, the surface member including a color-differentiated layer and a fusion interface layer, the color-differentiated layer including an inner surface and a first color, the fusion interface layer being disposed on the inner surface, and a melting point of the fusion interface layer being lower than that of the color-differentiated layer;
a placing and heating step including placing the surface member in the supercritical TPU foaming mold, heating the supercritical TPU foaming mold with a heating temperature below a melting point of the color-differentiated layer, and causing the fusion interface layer to be in a molten state;
a material injection step including injecting a fluid-state main body member into the supercritical TPU foaming mold, the fluid-state main body member having a melting point close to that of the fusion interface layer and a second color different from the first color;
a foaming and fusion step including performing a supercritical foaming process on the fluid-state main body member, causing the fluid-state main body member to foam, fuse and bond integrally with the fusion interface layer of the surface member; and
a cooling and curing step including cooling the foamed main body member, forming a solid main body member integrated with the surface member.

2. The method for integrally molding multicolor products using the supercritical thermoplastic polyurethane foaming mold as claimed in claim 1, wherein the main body member has a melting point of 180-200 °C, a melting point of the color-differentiated layer is 220-230 °C, while the fusion interface layer has a melting point of 190-200 °C.

3. The method for integrally molding multicolor products using the supercritical thermoplastic polyurethane foaming mold as claimed in claim 1, wherein the main body member is made of polyether TPU, the color-differentiated layer is made of polyester TPU, and the fusion interface layer is made of hot-melt polyurethane adhesive.

4. The method for integrally molding multicolor products using the supercritical thermoplastic polyurethane foaming mold as claimed in claim 1, wherein the supercritical TPU foaming mold includes a lower mold, an upper mold positioned above the lower mold, and a middle mold located between the lower mold and upper mold, the middle mold includes a hollow annular portion, the surface member is disposed in the hollow annular portion, and an outer surface of the color-differentiated layer contacts an annular surface of the hollow annular portion.
